(19) United States
(12) Patent Application Publication
(10) Pub. No.: US 2014/0119877 A1
(43) Pub. Date: May 1, 2014

(54) TRASH CONTAINER STOWING ASSEMBLY

(71) Applicants: Ibolya Violet Imre, North Royalton, OH (US); Louis Imre, North Royalton, OH (US)

(72) Inventors: Ibolya Violet Imre, North Royalton, OH (US); Louis Imre, North Royalton, OH (US)

(21) Appl. No.: 13/665,975

(22) Filed: Nov. 1, 2012

(51) Int. Cl. B65F 1/14

(52) U.S. Cl. CPC B65F 1/141
USPC 414/810; 248/218.4; 220/676

(57) ABSTRACT

A trash container stowing assembly (10) for installation on a lawn area (11) next to a roadway (12) adjacent a curb (13). The assembly (10) comprises a bracket (20) propped up by a post (30) anchored to the ground. Trash containers (40) having side handles (42) are secured to hooks on opposite sides of the bracket (30) so as to prevent them from falling over, blowing off, rolling away, or otherwise causing havoc on the roadway (12).

### RELATED APPLICATION

This application claims priority under 35 U.S.C. §119(e) to U.S. Provisional Patent Application No. 61/567,566 filed on Dec. 6, 2011. The entire disclosure of this provisional application is hereby incorporated by reference. To the extent that any inconsistencies exist between the present disclosure and that of the incorporated provisional application, the present disclosure should be used to govern interpretation for the purposes of avoiding indefiniteness and/or clarity issues.

### BACKGROUND

Trash creation, accumulation, and collection has become a routine part of residential life. Typically, residents will accumulate trash from their homes into large outside containers placed near an entrance or exit door. On a predetermined day of the week, the containers are moved to a location adjacent the street (e.g., the curb) for convenient emptying by a trash collection crew.

### SUMMARY

A trash container stowing assembly is provided which can be easily installed on a lawn area next to a roadway (e.g., adjacent a curb). The stowing assembly is adapted to secure conventional trash containers so as to prevent them from falling over, blowing off, rolling away, or otherwise causing havoc on the roadway.

### DRAWINGS

FIGS. 1-5 show the stowing assembly installed on a lawn area adjacent a roadway.

FIGS. 6-8 show various views of a bracket of the stowing assembly.

### DESCRIPTION

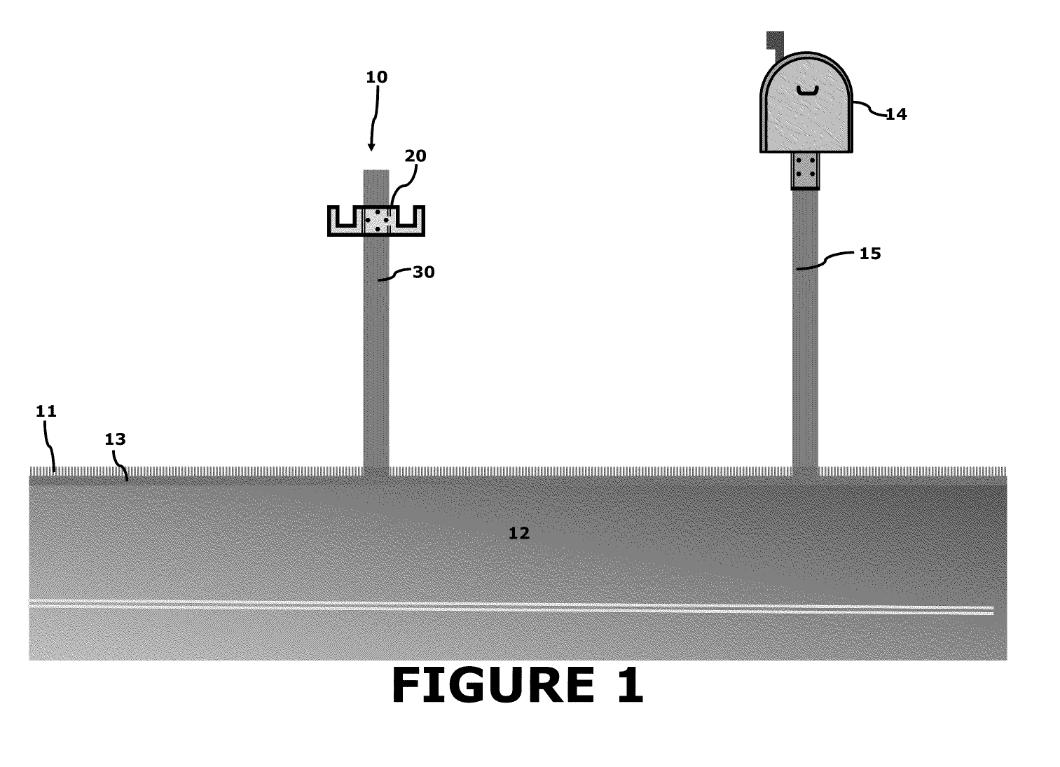

Referring now to the drawings, and initially to FIG. 1, the trash container stowing assembly 10 is shown installed on lawn area 11 next to a roadway 12 (e.g., adjacent the curb 13). The assembly 10 is no more intrusive than, and just as attractive as, a conventional mailbox 14 and associated post 15 installed on the lawn 11.

The trash container stowing assembly 10 generally comprises a bracket 20 and a post 30. The post 30 is anchored in the ground and the bracket 20 is attached thereto. The post 30 can be similar to the post 15 used for the mailbox 14. In other words, for example, it can be wooden, plastic, or metal, and/or it can have a square, circular or other cross-sectional shape.

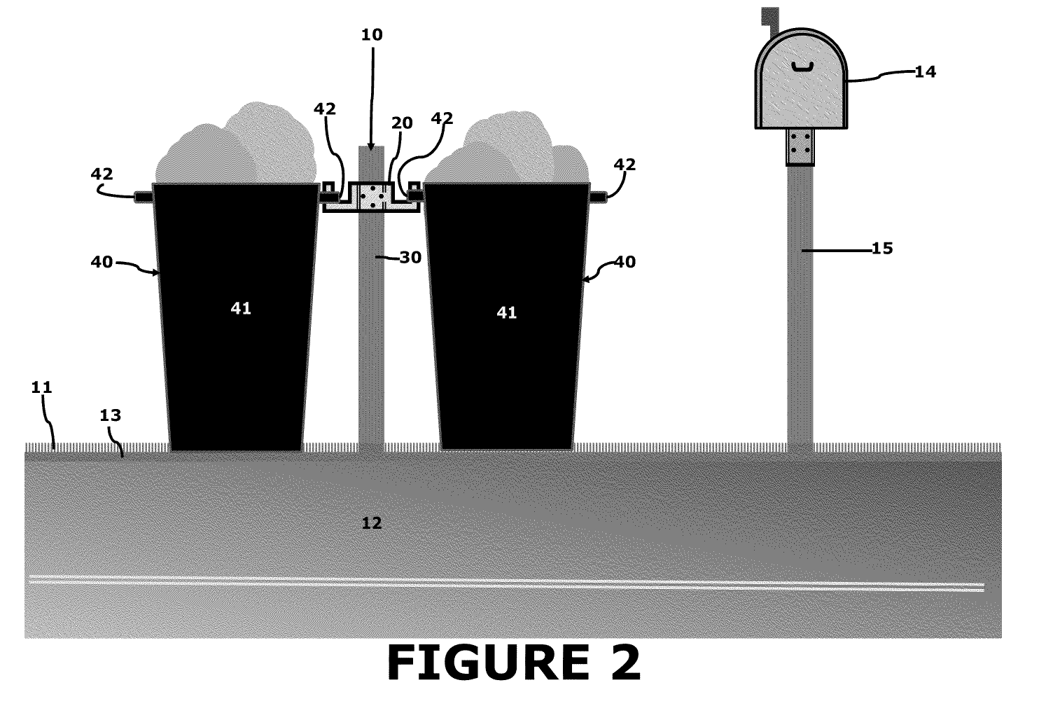

As shown in FIGS. 2-5, the stowing assembly 10 is adapted to accommodate at least one conventional trash container 40 and, in the illustrated embodiment, it is adapted to accommodate two such containers 40. Such containers 40 are often made of plastic (e.g., polyethylene) and capacities in the range of twenty to forty gallons. That being said, using nonplastic containers and/or different capacity containers with the stowing assembly 10 is feasible and foreseeable.

Each trash container 40 comprises a cylindrical trash-holding receptacle 41 with side handles 42 attached thereto. The handles 42 are situated for lifting, carrying, or otherwise maneuvering the receptacle 41. Although many handle designs may be employed, most include an opening for finger insertion when they are being grasped.

As shown in FIG. 2, when the trash containers 40 are full (or at least partially filled), their handles 42 can be hooked onto to the bracket 20. The bracket 20 can be situated at such a height on the post 30 that the containers 40 rest on the ground when they are hooked to the bracket. The hooking should require only a slight lifting of one side the container 40.

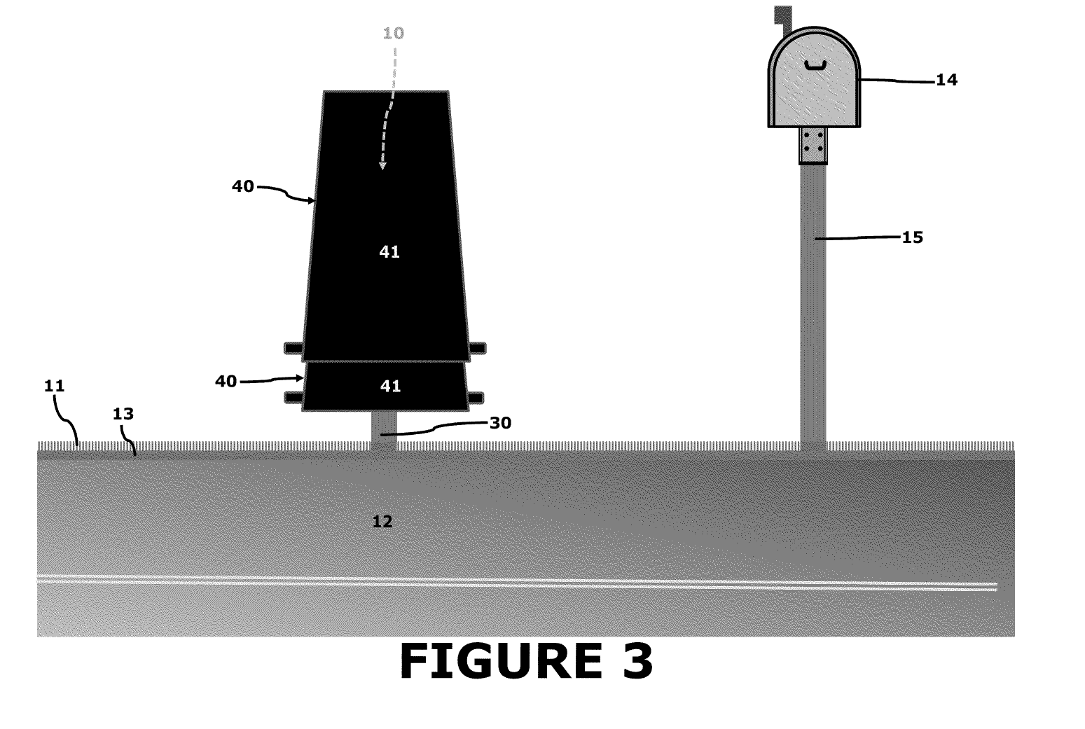

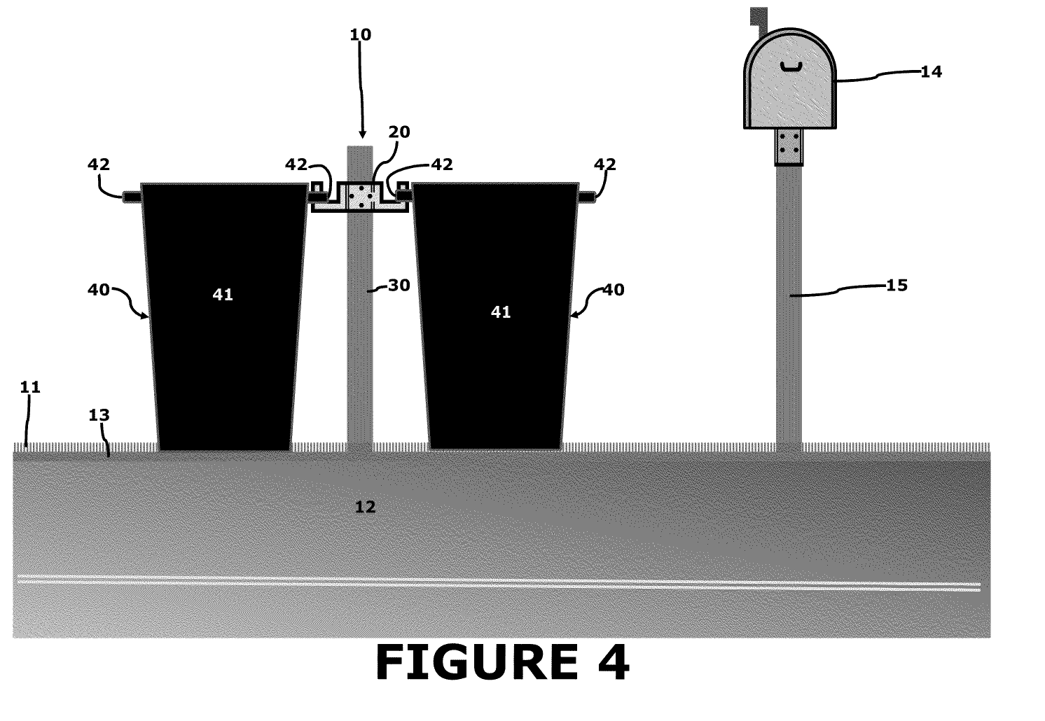

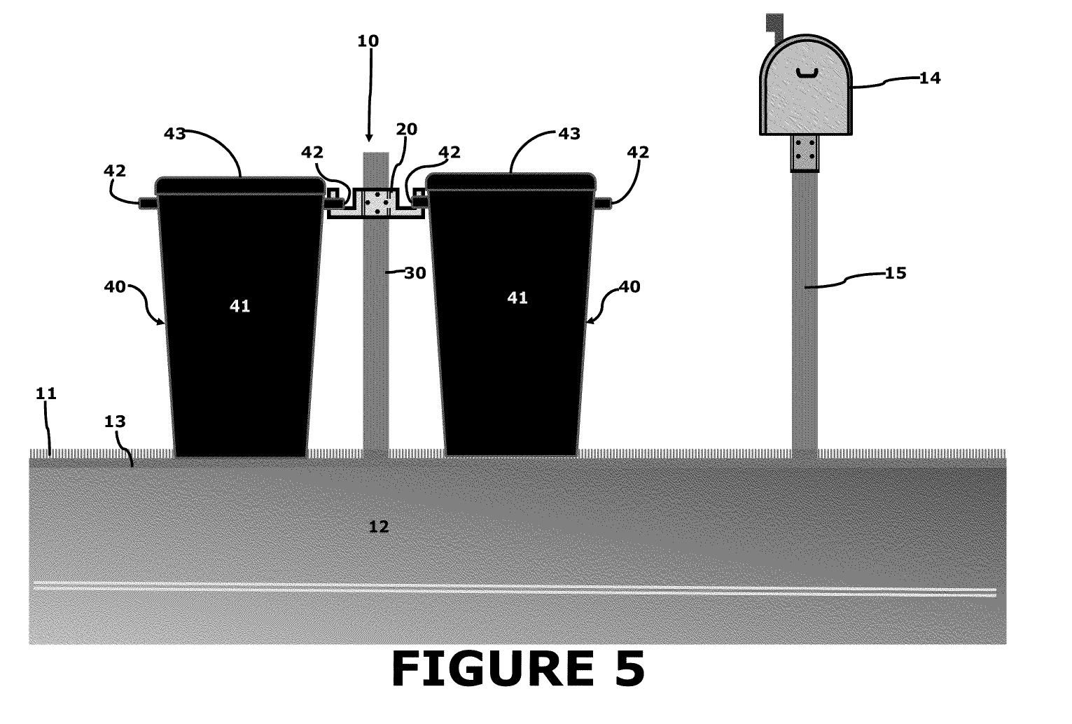

As shown in FIG. 3, after the trash containers 40 are emptied, they can be inverted and placed over the post 30 (and the bracket 30). Alternatively, as shown in FIG. 4, the emptied trash containers 40 can be rehooked to the bracket 20. And as shown in FIG. 5, the latter returning step may be preferred when the containers 40 include lids 43.

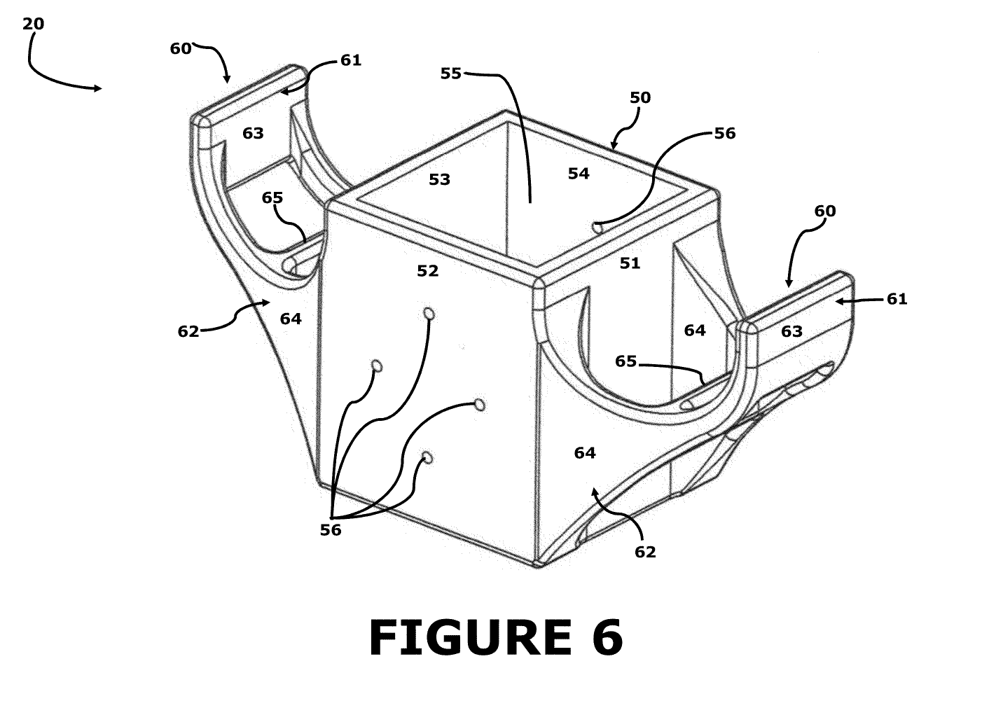

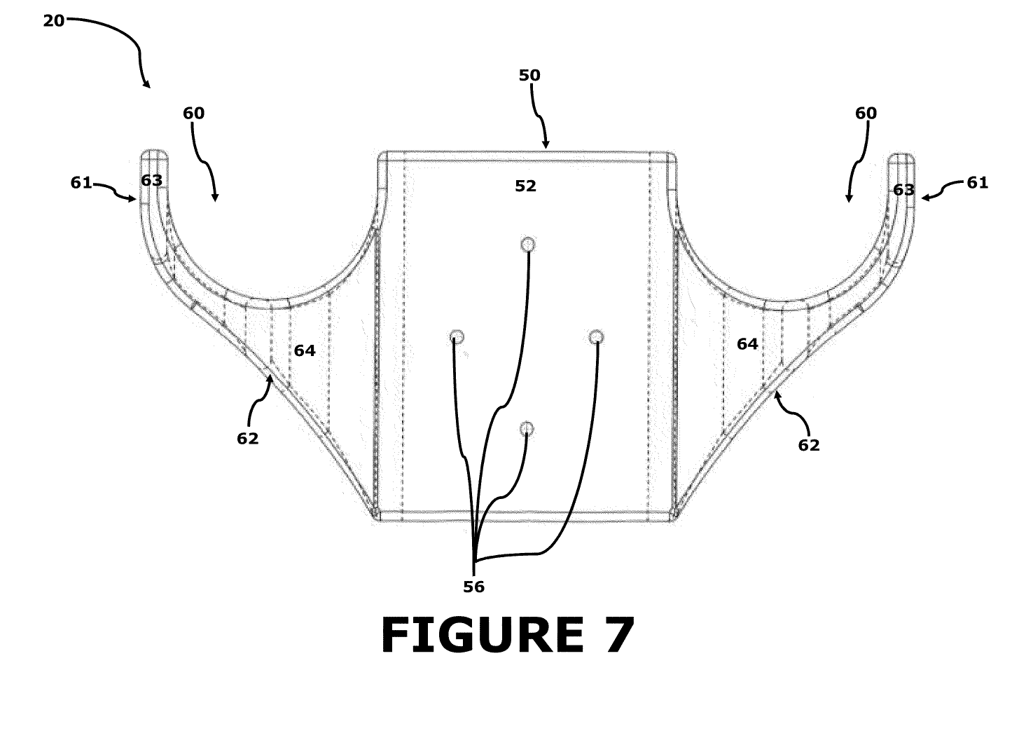

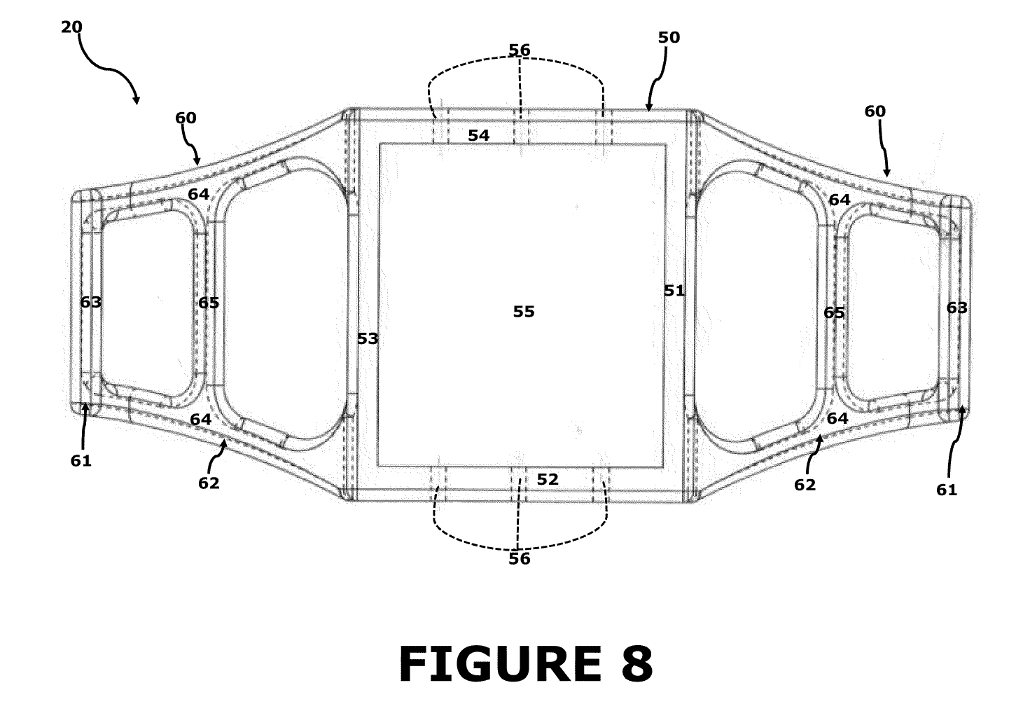

Referring now to FIG. 6, the bracket 20 comprises a sleeve 50 and a hook 60 attached thereto and extending laterally therefrom. As best seen by referring briefly back to FIGS. 1-5, the hooks 60 of the bracket 20 can extend laterally outward from the sleeve 50 in a direction substantially parallel to the roadway 12.

The sleeve 50 can have an open top, an open bottom, and lateral walls 51-54. The lateral walls 51-54 define a post-receiving chamber 55 which mirrors the cross-sectional shape of the post 30. Thus, if the post 30 has a square cross-sectional shape, the chamber 55 will likewise have a square cross-sectional shape.

If the stowing assembly 10 is intended to accommodate two trash containers 40, a hook 60 can extend from each of two opposing sides of the sleeve 50. For example, in the illustrated embodiment, a hook extends laterally outward from the wall 51 and the wall 53. Openings 56 are provided on wall 52 and wall 54 which receive fasteners (e.g., nails, screws, bolts, rivets, etc.) for securing the sleeve 60 to the post 30.

Each hook 60 includes a distal handle-engaging portion 61 and a proximal sleeve-bridging portion 62. The hook's distal portion 61 which can comprise a ledge 63 oriented substantially parallel with the attached-to wall 51/53. The bridge portion 62 can comprise a pair of arms 64 each of which is attached to an edge of the attached-to-wall 51/53 and which is aligned perpendicular therewith. A web 65 can extend between the arms 64 at location laterally intermediate the ledge 63 and the corresponding wall 51/53.

The sleeve 50, the sleeve walls 51-54, the hook 60, the hook portions 61-62, and/or the bracket 20 can be made of plastic (e.g., polypropylene). Additionally or alternatively, the sleeve walls 51-54 can be formed (e.g., molded) in one piece with each other, the hook portions 61-62 can be formed (e.g., molded) in one piece with each other, and/or the sleeve 50 and the hooks 60 can be formed (e.g., molded) in one piece with each other. However, nonplastic brackets 20 and/or multi-piece brackets 20 are equally possible and practical. For example, a metal sleeve could be attached to a metal hook parts by soldering, welding, or other attachment techniques. Furthermore, a plastic sleeve 50 could be combined with metal hooks 60 or vice-a-versa.

To assemble the stowing assembly 10, the lower portion of the post 30 is anchored in the ground. The sleeve 50 is then oriented with respect to the post 30 so that the hooks 60 will extend in the desired directions. The post's upper portion is then inserted through the chamber 55 and vertically adjusted to a height whereat the hooks 60 are at the same level as the handles 42 on the trash containers 40. The sleeve 50 can then permanently mounted on the post 30 by fasteners inserted through the openings 56.

One may now appreciate that the stowing assembly safely and securely stows trash containers 40 adjacent the curb 13 for convenient pickup. Although the stowing assembly 10, the bracket 20, the post 30, the trash containers 40, the sleeve 50, and/or the hooks 60 have been shown and described with respect to certain embodiments, it is obvious that equivalent alterations and modifications will occur to others skilled in the art upon the reading and understanding of this specification and the annexed drawings. For example, the stowing assembly 10 needs not be placed by roadside 12 and/or curb 13, as it could also find application in other areas. Also, a one-piece assembly 10 wherein the bracket 20 and the post 30 are formed in one piece is possible and predictable. Additionally or alternatively, trash bags can also or instead be served by the stowing assembly 10 by, for example, latching their tie handles to the bracket hooks 60.

### REFERENCE NUMBERS

10 stowing assembly
11 lawn area
12 roadway
13 curb
14 mailbox
15 mailbox post
20 bracket
30 post
40 trash containers
41 trash-holding receptacle
42 side handles
43 lid
50 sleeve
51 lateral wall
52 lateral wall
53 lateral wall
54 lateral wall
55 post-receiving chamber
56 fastener-receiving openings
60 hook
61 distal handle-engaging portion
62 proximal sleeve-bridging portion
63 ledge

1. A bracket for installation on a post to make a trash container stowing assembly, said bracket comprising a sleeve and a hook attached thereto;
wherein the sleeve includes wall structure defining a post-receiving chamber; and
wherein the hook extends laterally outward from the wall structure and includes a distal handle-engaging portion.

2. A bracket as set forth in claim 1, wherein the sleeve and the hook are made of plastic and are formed in one piece with each other.

3. A trash container stowing assembly comprising a bracket as set forth in claim 1 and a post having an upper portion received in the sleeve's post-receiving chamber.

4. A trash container stowing assembly as set forth in claim 3, further comprising fasteners fastening the sleeve to the post, wherein the fasteners extend through holes in the sleeve.

5. A trash container stowing assembly as set forth in claim 3, installed on a lawn area next to a roadway, wherein the hook extends laterally outward from the sleeve in a direction substantially parallel to the roadway.

6. A trash container stowing assembly as set forth in claim 3, and a trash container having a trash-holding receptacle and side handles, wherein one of the side handles is hooked by the distal handle-engaging portion of the bracket's hook.

7. A trash container stowing assembly and a trash container as set forth in claim 6, wherein the trash-holding receptacle is at least partially filled with trash.

8. A method of trash collection with the stowing assembly and trash container set forth in claim 7, said method comprising the steps of:
unhooking the side handle of the trash container from the bracket;
emptying trash from the container's trash-holding receptacle; and
returning the emptied trash container to the stowing assembly.

9. A method as set forth in claim 8, wherein said returning step comprises inverting the emptied trash container and placing it over the post.

10. A method as set forth in claim 8, wherein said returning step comprises rehooking the emptied trash container to the bracket of the stowing assembly.

11. A bracket as set forth in claim 1, comprising two hooks attached to the sleeve, wherein the hooks extend laterally outward from opposing sides of the hook's wall structure and wherein each hook includes a distal handle-engaging portion.

12. A bracket as set forth in claim 11, wherein the sleeve and the hooks are made of plastic and are formed in one piece with each other.

13. A trash container stowing assembly comprising a bracket as set forth in claim 11 and a post having an upper portion received in the sleeve's post-receiving chamber.

14. A trash container stowing assembly as set forth in claim 13, further comprising fasteners fastening the sleeve to the post, wherein the fasteners extend through holes in the sleeve.

15. A trash container stowing assembly as set forth in claim 13, installed on a lawn area next to a roadway, wherein the hooks extend laterally outward from the sleeve in opposite directions substantially parallel to the roadway.

16. A trash container stowing assembly as set forth in claim 13, and two trash containers each having a trash-holding receptacle and side handles, wherein one of the side handles of each container is hooked by the distal handle-engaging portion of the bracket's respective hooks.

17. A trash container stowing assembly and the trash containers as set forth in claim 16, wherein the trash-holding receptacles are at least partially filled with trash.

18. A method of trash collection with the stowing assembly and the trash containers set forth in claim 17, said method comprising the steps of:
unhooking the side handles of the trash containers from the bracket;
emptying trash from the containers' trash-holding receptacles; and
returning the emptied trash containers to the stowing assembly.

19. A method as set forth in claim 18, wherein said returning step comprises inverting the emptied trash containers and placing them over the post.

20. A method as set forth in claim 18, wherein said returning step comprises rehooking the emptied trash container to the bracket of the stowing assembly.
